(19) United States
(12) Patent Application Publication
(10) Pub. No.: US 2012/0259035 A1
(43) Pub. Date: Oct. 11, 2012

(54) METHOD FOR PREPARING A MASTERBATCH OF SYNTHETIC DIENE ELASTOMER AND SILICA

(75) Inventors: Julien Berriot, Les Martres De Veyre (FR); Benoît De Gaudemaris, Clermont-Ferrand (FR); Géraldine Laffargue, Clermont-Ferrand (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/503,501

(22) PCT Filed: Oct. 25, 2010
(86) PCT No.: PCT/EP10/66045

§ 371 Date: Jun. 21, 2012

(30) Foreign Application Priority Data
Oct. 30, 2009 (FR) 0957698

(51) Int. Cl. C08K 3/36; C08L 9/06

(52) U.S. Cl. 523/155; 524/575

(57) ABSTRACT

The invention relates to a method for preparing a silica/synthetic diene elastomer masterbatch, comprising the following successive steps:
doping the silica with an at least divalent metallic element;
preparing at least one dispersion of the resulting doped silica in water;
bringing a synthetic diene elastomer latex into contact with the aqueous doped-silica dispersion and mixing them together so as to obtain a coagulum;
recovering the coagulum; and
drying the recovered coagulum so as to obtain the masterbatch.

The invention relates to the preparation of a silica/synthetic diene elastomer masterbatch comprising at least a modified silica and a synthetic diene elastomer latex, in particular a styrene-butadiene copolymer. The term “masterbatch” denotes a composition based on an elastomer in which a filler and possibly other additives have been introduced.

The present invention relates in particular to the use of such a masterbatch for manufacturing diene rubber compositions reinforced with an inorganic filler, said compositions being intended for manufacturing tyres or semi-finished products for tyres, in particular treads for these tyres.

To obtain the optimum reinforcing properties conferred by a filler in a tyre tread and a high wear resistance, it is known generally to be appropriate for this filler to be present in the elastomeric matrix in a final form which is both as finely divided as possible and as uniformly distributed as possible. However, such conditions can be achieved only when this filler has a very good capability, on the one hand, of being incorporated into the matrix during compounding with the elastomer and of deagglomerating and, on the other hand, of being uniformly dispersed in this matrix.

As is known, carbon black has such capabilities, which is in general not the case of inorganic fillers, particularly silicas. This is because, for reciprocal affinity reasons, these inorganic filler particles have an annoying tendency to clump together in the elastomeric matrix. Such interaction has the deleterious consequence of limiting the dispersion of the filler and therefore the reinforcing properties to a level substantially below that which would be theoretically possible to achieve if all the inorganic filler/elastomer bonds capable of being created during the compounding operation were actually to be obtained. These interactions moreover tend to increase the viscosity in the uncured state of the rubber compositions and therefore to make them more difficult to process than when carbon black is present.

Since fuel saving and the need to protect the environment have become a priority, it has proved necessary to produce tyres having a reduced loading resistance without penalizing their wear resistance.

This has been made especially possible by the use, in the treads of these tyres, of novel rubber compositions reinforced with inorganic fillers, in particular specific silicas of the highly dispersible type, that are capable of rivalling from the reinforcing standpoint a conventional tyre-grade carbon black, while offering these compositions a lower hysteresis, which is synonymous with a lower rolling resistance for tyres containing them, and also improved grip on wet, snow-covered or icy ground.

Treads filled with such HD (highly dispersible) silica or HDS (highly dispersible silica) that can be used in tyres having a low rolling resistance, sometimes termed “green tyres”, due to the saving of energy offered to the user (“green tyre concept”), have been abundantly described. The reader may in particular refer to the patent applications EP 501 227, EP 692 492, EP 692 493, EP 735 088, EP 767 206, EP 786 493, EP 881 252, WO99/02590, WO99/02601, WO99/02602, WO99/06480, WO00/05300 and WO00/05301.

These documents of the prior art teach the use of HD silicas having a BET specific surface area of between 100 and 250 m²/g. In practice, one HD silica having a high specific surface area used in the “green tyre” field is particularly the silica “Zeosil 1165 MP” (having a BET surface area of about 160 m²/g) sold by the company Rhodia. The use of this Zeosil 1165 MP silica makes it possible to obtain good compromises in terms of tyre performance, especially satisfactory wear resistance and rolling resistance.

The benefit of using silica having a high specific surface area lies mainly in the possibility of increasing the number of silica-elastomer bonds and therefore of increasing the level of reinforcement of the elastomer. This is why it appears advantageous to use, in tyre tread rubber compositions, silicas having a high specific surface area, possibly higher than that conventionally used, namely around 160 m²/g, so as in particular to improve the wear resistance of these treads. However, the dispersibility of the filler and the increase in its specific surface area are considered to be conflicting properties. This is because a high specific surface area means an increase in the interactions between filler particles and therefore poor filler dispersion in the elastomer matrix and difficult processing.

Another type of solution for improving the dispersibility of the filler in the elastomer matrix has been envisaged, which consists in compounding the filler and the elastomer in the “liquid” phase. To do so, the process involves an elastomer in latex form, which is in the form of water-dispersed elastomer particles, and an aqueous dispersion of the filler, that is to say a silica dispersed in water, usually called a “slurry”. However, bringing the elastomer latex into contact with the slurry does not allow coagulation within the liquid medium, which coagulation would be necessary in order to achieve a solid which, after drying, would result in the desired silica/elastomer masterbatch being obtained. This is because silica aggregates are typically hydrophilic in nature and have an affinity with water. Thus, the silica aggregates have a higher affinity with water than with the elastomer particles themselves.

However, various solutions have been proposed for obtaining this coagulation and good dispersion of the filler in the elastomeric matrix in the “liquid” phase via the combined use of an agent for increasing the affinity between the elastomer and the silica, such as a coupling agent, and of an agent, called a coagulant, for producing the coagulation.

Thus, for example, the U.S. Pat. No. 5,763,388 proposes incorporating silica into the rubber latex by treating the silica with a cutting agent and mixing the resulting treated silica with conventional coagulants.

The patent EP 1 321 488 also proposes bringing an aqueous dispersion of negatively charged silica into contact with a diene elastomer latex and with an emulsion containing a polysulfide cutting agent in the presence of a coagulant, such as a polyamine.

The applicants have surprisingly discovered a method of obtaining a silica/elastomer masterbatch prepared in “liquid” phase without using either a coagulant or a coupling agent. Such a method makes it possible, in addition, not only to achieve a very good yield (greater than 80 wt %) in respect of the amount of filler introduced beforehand, but also good dispersion of the filler in the elastomeric matrix.

Of course, such a method seems to be all the more beneficial if it is carried out with highly dispersible silicas, as presented above.

The method for preparing a silica/synthetic diene elastomer masterbatch according to the invention comprises the following successive steps:
doping the silica with an at least divalent metallic element;
preparing at least one dispersion of the resulting doped silica in water;
bringing a synthetic diene elastomer latex into contact with the aqueous doped-silica dispersion and mixing them together so as to obtain a coagulum;
recovering the coagulum; and
drying the recovered coagulum so as to obtain the masterbatch.

According to one embodiment of the method, the coagulum recovery step is carried out by a filtering operation.

According to another embodiment, the coagulum recovery step is carried out by a centrifuging operation.

Preferably, the synthetic elastomer latex is a styrene-butadiene copolymer, or SBR, latex and more preferably still the synthetic elastomer latex is an SBR prepared in emulsion.

According to one embodiment of the invention, the silica is a precipitated silica.

Advantageously, the metallic element is aluminium, one of the following conditions preferably being satisfied:

(i) the formulation pH is between 3.5 and 5.5 and the level of aluminium doping of the silica is equal to or greater than 0.5% by weight;
(ii) the formulation pH is greater than 5.5 and the level of aluminium doping of the silica is equal to or greater than (2×pH-10).

Another subject of the invention is a silica/synthetic diene elastomer masterbatch prepared according to the method comprising the following successive steps:
doping the silica with an at least divalent metallic element;
preparing at least one dispersion of the resulting doped silica in water;
bringing a synthetic diene elastomer latex into contact with the aqueous doped-silica dispersion and mixing them together so as to obtain a coagulum;
recovering the coagulum; and
drying the recovered coagulum so as to obtain the masterbatch.

Yet another subject of the invention is a rubber composition based on at least one silica/synthetic diene elastomer masterbatch prepared according to the invention in accordance with the aforementioned invention, and also a finished or semi-finished article, a tyre tread, and a tyre or semi-finished product comprising at least one such rubber composition.

The expression “doping the silica with a metallic element” is understood to mean modifying the surface of the silica so as to incorporate this metallic element into the interior of the peripheral layers of the silica and/or on the surface of this silica. By extension, the term “doped silica”, in particular “aluminium-doped silica”, is understood to mean a silica having a metallic element, in particular aluminium, in the interior of its peripheral layers and/or on its surface.

### I-Measurements and Tests

### I-1) Measuring the Aluminium Doping

This method is used to assay the surface aluminium of the doped silicas by atomic emission spectroscopy (ICP-AES). These silicas are prepared by doping a commercial silica.

Since the silica is not digested, this method does not allow the aluminium present in the core of the silica to be assayed.

a) Principle

The aluminium is dissolved with hot sulphuric acid and then assayed by inductively coupled plasma-atomic emission spectroscopy (ICP-AES). The surface aluminium content is calculated by subtracting the aluminium content of the starting commercial silica. The calibration range used is 0 to 20 mg/l of aluminium; two measurements are carried out on each specimen.

b) Apparatus
Precision (0.1 mg scale) balance;
Funnels;
100 ml class A volumetric flasks;
250 ml class A volumetric flasks;
10 ml measuring cylinder or 10 ml acid dispenser;
50 ml measuring cylinder;
a 0.1-1 ml variable-volume calibrated micropipette (for example an Eppendorf micropipette);
a 0.5-5 ml variable-volume calibrated micropipette (for example an Eppendorf micropipette);
Cellulose acetate syringe filters of 0.45 μm pore diameter;
30 ml sample holders;
ICP spectrometer (for example: a Jobin Yvon Activa M spectrometer);
250 ml wide-necked Erlenmeyer flasks;
Sand bath.

c) Reactants
Ultrapure water;
Concentrated nitric acid (for example RP NORMAPUR REF 20.422.297)
   d=1.41%
   % HNO₃=65;
Concentrated hydrochloric acid (for example RP NORMAPUR REF 20.252.290)
   d=1.18%
   % HCl=37;
Concentrated sulphuric acid (for example RP MERCK REF 1.00731.1000)
   d=1.84%
   % H₂SO₄=95-97;
1 g/l aluminium standard solution (for example MERCK REF HC 812641).

d) Operating Method

d)-1—Preparation of a 5 Vol % Sulphuric Acid Solution

200 ml of demineralized water are introduced into a 1-litre class A volumetric flask using a measuring cylinder. Next, 50 ml of concentrated (3.4) sulphuric acid are introduced using a measuring cylinder. After homogenization, the solution is left to cool down. The flask is brought up to the volume line with demineralized water.

d)-2—Preparation of the Silicas in an Open System on a Sand Bath

The measurements are carried out twice. It is preferable to perform a blank procedure during each series of measurements (preparation under the same conditions but with no specimen). The raw silicas before doping are also analyzed.
250 mg of silica is weighed in an Erlenmeyer flask;
20 ml of 5% (§5.1) sulphuric acid is poured into the flask;
Using a sand bath, the contents are heated until completely dry;
The flask is left to cool down;
The walls of the Erlenmeyer flask are rinsed with a little water and then 12.5 ml of 65% (§3.2) concentrated nitric acid and 12.5 ml of 37% concentrated hydrochloric acid are added (only for Al-doped silicas) (§3.3);
The contents are brought to boiling;
The flask is left to cool down and then the contents quantitatively transferred into a 250 ml calibrated flask;
The flask is brought up to the volume line using demineralized water;
The solution is filtered using a 0.45 μm syringe filter;
The ICP-AES analysis is carried out.

d)-3—Preparation of the Calibration Range

### Preparation of the Aluminium Calibration Range.

The reactants given in the following table correspond to the concentrations mentioned above in section c).

| E0 | E1 | E2 | E3 | E4 | |
|---|---|---|---|---|---|
| 0 | 5 | 15 | 30 | 20 | mg/l of aluminium |
| 90 | 89.5 | 89.0 | 88.5 | 88.0 | ml of ultrapure water |
| 5 | 5 | 5 | 5 | 5 | ml of hydrochloric acid using a |
| | | | | | dispenser |
| 5 | 5 | 5 | 5 | 5 | ml of nitric acid using a dispenser |
| 0 | 0.5 | 1.0 | 1.5 | 2.0 | ml of 1000 mg/l aluminium |
| | | | | | calibration solution using a |
| | | | | | micropipette |
| 100 | 100 | 100 | 100 | 100 | total volume (in ml) |

These calibration standards keep for four months.
Preparation of a 10 mg/l Validation Control

The verification control is prepared during each series of measurements in the same way as the calibration standards above, by introducing 1 ml of 1 g/l aluminium standard solution of a different batch, enabling the calibration to be validated. The verification control is not kept after use.

d)-4—Assaying by ICP-AES

### Analysis Sequence

1—Calibration;
2—10 mg/l (magnesium) or 10 mg/l (aluminium) validation control;
3—Specimens+blank procedure;
4—ES (20 mg/l aluminium) verification standard.
   Validation of the calibration for the 0-50 mg/l aluminium range:
   Validation control (theoretical value: 20 mg/l)
   Tolerances: 19.6 mg/1<[aluminium]<20.4 mg/l.
   Validation of the analysis sequence (this validation demonstrates that there was no drift) for the 0-50 mg/l aluminium range:
   ES verification standard (theoretical value: 50 mg/l)
   Tolerances: 49 mg/1<[aluminium]<51 mg/l.

### Activa ICP-AES Parameters

### Plasma and Spray Settings:

Cyclonic spray chamber (Scott chamber);
Pump speed: 20 rpm;
Plasma gas flow rate: 12 l/min;
Sheath gas flow rate: 0.2 l/min;
Auxiliary gas flow rate: 0 l/min;
Spray flow rate*: 0.87 ml/min;
Spray pressure*: 2.97 bar;
Rinsing time: 20 s;
Transfer time: 30 s;
Stabilization time: 20 s;
Concentric spray nozzle (Meinhard);
Generator power: 1100 W.

### Detection Parameters:

| Parameters | Al |
|---|---|
| Analysis lines | λ_{Al} = 394.401 nm; |
| | straight background: 0.0741 nm |
| | λ_{Al} = 396.152 nm |
| | straight background: 0.0783 |
| Integration time | 0.5 s |
| Calculation mode | average (1 point) |
| Observation zone | 1-512 |
| Input slot | 10 |
| Number of duplicates | 3 |

e) Results

The surface aluminium content of the specimen (in wt %) is given by:
Surface Al=% Al_{doped silica}−% Al_{raw silica};

### Example: Al_{160 MP}=0.23 wt %.

The measurement uncertainty was determined on the Jobin Yvon Activa M ICP-AES spectrometer using three measurements per day over six days. The uncertainty given is three standard deviations. For a 2.53 wt % Al-doped silica, the uncertainty is ±0.23 wt %, which corresponds to a relative uncertainty of 9.09%.

### I-2) pH Measurement

The pH is measured using the following method derived from the ISO 787/9 standard (pH of a 5% suspension in water).

Apparatus
Mettler Toledo MP225 pH meter;
Electrodes with automatic temperature compensation:
   Inlab®Reach Pro electrode (for syntheses and pH of slurries)
   Inlab®Solids Pro electrode (for pH of formulations)
Heidolph MR3003 heated magnetic stirrer.

Small Equipment
100 ml glass beaker (diameter: 4.7 cm; height: 7 cm) for pH of an aqueous silica dispersion;
250 ml glass beaker (diameter: 6.5 cm; height: 9.3 cm) for pH of formulations;
Bar magnets matched to the size of the beakers;
5 L glass double-walled reactor.

Operating Method

Operating method for measuring the pH of aqueous dispersions or formulations:
1/Calibration of the electrode with 4.01, 7.01 and 10.01 pH buffer solutions;
2/Aqueous dispersion (or formulation) stirred by magnetic stirring at 500 rpm;
3/Immersion of the electrode in the beaker and reading of the pH.
Operating method for measuring the pH during the doping syntheses:
1/Calibration of the electrode with 4.01, 7.01 and 10.01 pH buffer solutions;
2/Reaction mixture stirred by magnetic stirring (about 650 rpm);
3/Immersion of the electrode in the reactor and reading of the pH.

### I-3) Measurement of the Amount of Filler by TGA

The purpose of this operating method is to quantify the categories of the constituents of the rubber compounds. Three temperature ranges each corresponding to one category of constituents, are distinguished:
between 250 and 550° C., corresponding to organic matter: elastomers, oils, vulcanizing agents, etc.;
between 550 and 750° C., corresponding to losses;
above 750° C., corresponding to ash: ZnO, possibly silica, etc.

The method applies both to uncured compounds and to cured compounds.

a)—Apparatus
Thermogravimetric analysis system based on a Mettler Toledo analyzer: TGA 851 or DSC1 TGA model;
1/100 mg balance (make and model of the balance);
70 μl (coverless) alumina crucibles (Mettler Toledo reference 00024123);
various laboratory items of equipment: tweezers, scissors, etc.

b)—Principle

The weight losses of a compound specimen subjected to a temperature rise are monitored. The temperature rise takes place in two steps:

1/Heating from 25 to 550° C. in an inert atmosphere (N₂) to evaporate the volatile matter and to pyrolyze the organic matter. The volatility of the products resulting therefrom gives rise to a weight loss corresponding firstly (below 300° C.) to the volatile matter and then to the organic matter present initially in the compound.
2/Heating continuation up to 750° C. in an oxidizing atmosphere (Air or O₂) to burn off the carbon black (and/or carbon material). The volatility of the products that results therefrom gives rise to a weight loss corresponding to the initial amount of carbon black (and/or carbon material).

The products that remain after these treatments constitute the ash which is generally composed of inorganic materials, e.g. ZnO, silica, etc.

c)—Measurements

c)-1—Specimen Preparation

The amount of product analyzed has to be weighed to within 0.01 mg and is between 20 and 30 mg. It is then placed in a 70 μl alumina crucible (coverless).

c)-2—Definition of the “Method” (Temperature Program)
The following segments are defined in succession:
   1st segment: dynamic segment from 25 to 550° C. at 50° C./min in nitrogen (40 ml/min);
   2nd segment: dynamic segment from 550 to 750° C. at 10° C./min in air (or O₂) (40 ml/min);
The “blank curve subtraction” field is activated.

Any measurement is automatically corrected by a blank curve. The latter is produced under the same conditions as the measurement, but with an empty crucible. It is stored and used for all the following measurements (no new blank test necessary before each measurement).

c)-3—Starting the Measurement

By consulting the control window of the furnace, a prior check is made to ensure that the nitrogen and air flow rates (40 ml/min) are suitably set. If not, they are adjusted using the adjustments located on the “gas box”.

Blank Curve
The blank curve is produced using the procedure described in the TGA operating manual.

Measurement
The measurement is carried out using the procedure described in the TGA operating manual.

c)-4—Exploitation of the Curve

Following the instructions of the TGA operating manual:
the curve to be exploited is selected and opened;
the 1st plateau, corresponding to the volatile matter, is defined in this curve between 25° C. and approximately 250° C. respectively;
the weight loss corresponding to the amount of volatile matter (in %) is calculated;
the 2nd plateau, corresponding to the organic matter, is defined in this curve between the temperature of the approximately 250° C. 1st plateau and 550° C. respectively;
the weight loss corresponding to the amount of organic matter (in %) is calculated;
the 3rd plateau, corresponding to the losses, is defined in this curve between 550° C. and 750° C. respectively;
the weight loss corresponding to these losses (in %) is calculated; and
the residue or ash content in % is calculated.

c)-5—Presence of Volatile Matter

For certain compounds containing volatile matter that may evaporate at room temperature, there is a risk of loss of material between preparing the specimen and actually starting the measurement.

These losses are not taken into account by the apparatus.

To take these losses into account and obtain the actual composition of the compound, the following procedure may be carried out:

Steps c)-1 to c)-3 described above are carried out with the following two setpoints:
during preparation of the specimen: the weight of the empty crucible (P0) and the weight of the specimen P1 are noted;
during execution of the measurement: the “crucible weight” field and the “specimen weight” field are denoted by P0 and P1 respectively.

For the implementation (step c)-4), the TGA machine takes into account, for determining the losses, the mass of the specimen P2 which it calculates at the effective start of the measurement from the weight of the crucible, this being of paramount importance for calculating the residue; P2 is calculated by the TGA machine taking into account the mass P3 (crucible+specimen) at the time T0−P0.

The amounts of the various constituents and that of the residue are calculated relative to the specimen weight P1 defined during the preparation and not relative to P2.

The amount of volatile matter then calculated by the apparatus is erroneous since part of the volatile matter MV, i.e. (P1-P2), has evaporated during the waiting period between preparation and actual start of the measurement. The MV values must therefore be manually recalculated:
in terms of mass: MV (in mg)=(P1-P2) (in mg)+1st plateau losses (in mg);
in terms of amounts: T×MV (in %)=100×MV (in mg)/P1, or 100−1st plateau residue (in %).

c)-6—Amount of Filler in % mo

This amount is expressed in % mo, i.e. percentage of organic matter, and obtained by calculation when the TGA measurement is interpreted using the following formula:

T×filler (in % mo)=100×[(D)/(B+C)]

In this formula, B represents the percentage of organic matter (for the interval between 250 and 550° C.), C represents the percentage of losses (between 550 and 750° C.) and D represents the percentage of residue (above 750° C.).

### I-4) Measurement of the Coagulation Yield

The coagulation yield corresponds to the ratio of the recovered dry mass (from which the mass of volatile matter as defined in the TGA measurement protocol in the previous paragraphs has been removed) to the intended starting mass multiplied by one hundred.

### II. DETAILED DESCRIPTION OF THE INVENTION

The method for preparing a silica/synthetic diene elastomer masterbatch according to the invention comprises the following successive steps:
doping the silica with an at least divalent metallic element;
preparing a dispersion of the resulting doped silica in water;
bringing a synthetic diene elastomer latex, in particular a styrene-butadiene copolymer, or SBR, latex, into contact with the doped silica dispersion and mixing them together; and
recovering and drying the masterbatch thus obtained.

### II-1) Preparation of the Aqueous Silica Dispersion

In the first step of the method, the silica is doped with an at least divalent metallic element. As an at least divalent metallic element, aluminium may be particularly mentioned. This step of “doping” the silica may be advantageously carried out according to the protocol explained in detail in the patent application WO 02/051750. The doping level obtained corresponds to the percentage by weight of aluminium per one hundred parts by weight of silica.

For the invention, any silica (SiO₂) known to those skilled in the art may be used, especially any precipitated or pyrogenic silica having a BET surface area and a CTAB specific surface area that are both less than 450 m²/g, preferably ranging from 30 to 400 m²/g. In particular, it is possible to use a highly specific silica (or “HDS”). For example, the following silicas may be mentioned: Ultrasil 7000 and Ultrasil 7005 from Degussa; Zeosil 1165 MP, 1135 MP and 1115 MP silicas from Rhodia; Hi-Sil EZ150G silica from PPG; Zeopol 8715, 8745 and 8755 silicas from Huber; and silicas having a high specific surface area as described in the application WO 03/16837.

It is preferred to produce a doped silica having a doping level equal to or greater than 2% by weight and even more preferably greater than 2.5% by weight, the doping level representing the aluminium content present in the doped silica expressed by weight.

The doped silica obtained is then dispersed in water, preferably so as to obtain a dispersion of sufficient viscosity to be easily “handlable”. For example, an aqueous dispersion of doped silica with a silica content of 4% by weight in water may be produced.

Advantageously, the dispersion is sonicated so as to stabilize the aggregates in the water, thereby making it possible to improve the aqueous doped-silica dispersion in the masterbatch subsequently produced. This sonication may especially be carried out using a 1500 watt Vibracell generator manufactured by Sonics and Materials Inc. with a PTZ (reference 75010) crystal piezoelectric converter, a booster for the probe and a titanium alloy probe 19 mm in diameter (for a height of 127 mm).

It may be useful to add an acidifying agent to this aqueous doped-silica dispersion, such as strong acids or weak acids, so as to enable the pH of the aqueous doped-silica dispersion to be modified so as to obtain the desired formulation pH upon bringing the two dispersions described below into contact with each other.

A person skilled in the art must then perform several compacting operations so as to adjust the pH of the aqueous dispersion in order to obtained the desired formulation pH. A person skilled in the art knows that it is not possible to determine a priori, according to the volumes poured and the pH of each of the dispersions, what the pH of the formulation will be, owing to the very many variables associated with the nature of the elastomer latex that have an influence on the changes in pH.

### II-2) Synthetic Rubber Latex

As is known, the term “diene” elastomer or rubber should be understood to mean an elastomer (i.e. a homopolymer or copolymer) at least partly obtained from diene monomers (monomers having two carbon-carbon double bonds, whether conjugated or not).

These diene elastomers may be classified in two categories: “essentially unsaturated” and “essentially saturated”. The term “essentially unsaturated” is understood in general to mean a diene elastomer resulting at least partly from conjugated diene monomers, having a number of diene units or units of diene origin (conjugated dienes) greater than 15% (mol %). Thus, diene elastomers such as butyl rubbers or diene/alpha-olefin copolymers of the EPDM type do not fall within the above definition and may in particular be termed “essentially saturated” diene elastomers (small or very small number of units of diene origin, always less than 15%). In the “essentially unsaturated” diene elastomer category, the term “highly unsaturated” diene elastomer is understood in particular to mean a diene elastomer having a number of units of diene origin (conjugated dienes) that is greater than 50%.

Given these definitions, the expression “synthetic diene elastomer capable of being used in the compositions in accordance with the invention” is understood more particularly to mean:
(a) any homopolymer obtained by polymerizing a conjugated diene monomer having 4 to 12 carbon atoms;
(b) any copolymer obtained by copolymerizing one or more conjugated dienes with one another or with one or more vinylaromatic compounds having 8 to 20 carbon atoms;
(c) a ternary copolymer obtained by copolymerizing ethylene, an α-olefin having 3 to 6 carbon atoms with an unconjugated diene monomer having 6 to 12 carbon atoms, such as for example the elastomers obtained from ethylene, propylene with an unconjugated diene monomer of the aforementioned type, such as especially 1,4-hexadiene, ethylidene norbornene and dicyclopentadiene; and
(d) an isobutene/isoprene copolymer (butyl rubber) and also the halogenated, in particular chlorinated or brominated, versions of this type of copolymer.

The following are especially suitable as conjugated dienes: 1,3-butadiene, 2-methyl-1,3-butadiene, 2,3-di(C₁-C₅ alkyl)-1,3-butadienes, such as for example 2,3-dimethyl-1,3-butadiene, 2,3-diethyl-1,3-butadiene, 2-methyl-3-ethyl-1,3-butadiene and 2-methyl-3-isopropyl-1,3-butadiene; a 1,3-arylbutadiene; 1,3-pentadiene; and 2,4-hexadiene. Suitable vinylaromatic compounds are for example: styrene, ortho-, meta- and para-methylstyrene, and the commercial “vinyl-toluene” mixture, para-tert-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinylaromatic units. The elastomers may have any microstructure which depends on the polymerization conditions used, especially the presence or absence of a modifying and/or randomizing agent, and on the amounts of modifying and/or randomizing agent employed. The elastomers may for example be block, random, sequence or microsequence elastomers and may be prepared as a dispersion or in solution. They may be coupled and/or star-configured or else functionalized with a coupling and/or a star-configuring or functionalizing agent. For coupling to carbon black, mention may for example be made of functional groups comprising a C—Sn bond or amine functional groups such as for example aminobenzophenone. For coupling to a reinforcing inorganic filler such as silica, mention may for example be made of silanol or polysiloxane functional groups having a silanol end (as described for example in FR 2 740 778 or U.S. Pat. No. 6,013,718, and WO 2008/141702); alkoxysilane groups (as described for example in FR 2 765 882 or U.S. Pat. No. 5,977,238); carboxylic groups (as described for example in WO 01/92402 or U.S. Pat. No. 6,815,473, WO 2004/096865 or US 2006/0089445); or else polyether groups (as described for example in EP 1 127 909 or U.S. Pat. No. 6,503,973, WO 2009/000750 and WO 2009/000752). As other examples of functionalized elastomers, mention may also be made of epoxidized elastomers (such as SBR, BR, NR or IR).

Suitable polybutadienes are in particular: those having a content (in mol %) of −1,2 units between 4% and 80% or those having a content (in mol %) of cis-1,4 units greater than 80%; polyisoprenes; butadiene-styrene copolymers and in particular those having a T_{g} (glass transition temperature), measured according to ASTM D3418, of between 0° and −70° C. and more particularly between −10° C. and −60° C., a styrene content between 5% and 60% by weight and more particularly between 20% and 50%, and a content (in mol %) of −1,2 bonds of the butadiene part between 4% and 75%, and a content (in mol %) of trans-1,4 bonds between 10% and 80%; butadiene-isoprene copolymers and especially those having an isoprene content of between 5% and 90% by weight and a T_{g} of −40° C. to −80° C.; isoprene-styrene copolymers and especially those having a styrene content between 5% and 50% by weight and a T_{g} of between −5 C and −50° C. In the case of butadiene-styrene-isoprene copolymers, particularly suitable are those having a styrene content between 5% and 50%, more particularly between 10% and 40%, by weight, an isoprene content between 15% and 60%, and more particularly between 20% and 50%, by weight, a butadiene content between 5% and 50%, and more particularly between 20% and 40%, by weight, a content (in mol %) of −1,2 units of the butadiene part between 4% and 85%, a content (in mol %) of trans −1,4 units of the butadiene part between 6% and 80%, a content (in mol %) of −1,2 plus −3,4 units of the isoprene part between 5% and 70% and a content (in mol %) of trans −1,4 units of the isoprene part between 10% and 50% and more generally any butadiene-styrene-isoprene copolymer having a T_{g} between −5° C. and −70° C.

To summarize, the diene elastomer or elastomers of the composition according to the invention are preferably chosen from the group of highly unsaturated diene elastomers formed by polybutadienes (abbreviated as BR), synthetic polyisoprenes (IR), butadiene copolymers, isoprene copolymers and blends of these elastomers. Such copolymers are more preferably chosen from the group formed by styrene-butadiene (SBR) copolymers, butadiene-isoprene (BIR) copolymers, styrene-isoprene (SIR) copolymers and styrene-butadiene-isoprene (SBIR) copolymers.

The synthetic diene elastomer latex (or synthetic rubber latex) may consist of a synthetic diene elastomer already available in emulsion form (for example a styrene-butadiene copolymer, or SBR, prepared in emulsion), or of a synthetic diene elastomer initially in solution (for example an SBR prepared in solution) which is emulsified in an organic solvent/water mixture, generally by means of a surfactant.

Particularly suitable for the invention is an SBR latex, especially an SBR prepared in emulsion (or ESBR) or an SBR prepared in solution (or SSBR), and more particularly an SBR prepared in emulsion.

There are two broad types of processes for the emulsion copolymerization of styrene and butadiene. One of them, involving hot processing (carried out at a temperature close to 50° C.), being suitable for the preparation of highly branched SBRs, whereas the other, involving cold processing (carried out at a temperature that may range from 15° C. to 40° C.), enables more linear SBRs to be obtained.

For a detailed description of the effectiveness of several emulsifiers that can be used in said hot processing (depending on the amounts of said emulsifiers), the reader may for example refer to the two articles by C. W. Carr, I. M. Kolthoff and E. J. Meehan, University of Minesota, Minneapolis, Minesota which were published in Journal of Polymer Science, Vol. V, No. 2, pp. 201-206, 1950 and Vol. VI, No. 1, pp. 73-81, 1951.

As comparative examples of the implementation of said cold processing, the reader may for example refer to the article in Industrial and Engineering Chemistry, 1948, Vol. 40, No. 5, pp. 932-937 by E. J. Vandenberg and G. E. Hulse, Hercules Powder Company, Wilmington, Del. and to the article Industrial and Engineering Chemistry, 1954, Vol. 46, No. 5, pp. 1065-1073 by J. R. Miller and H. E. Diem, B.F. Goodrich Chemical Co., Akron, Ohio.

In the case of an SBR (ESBR or SSBR) elastomer, an SBR having an average styrene content for example between 20% and 35% by weight, or a high styrene content, for example 35 to 45% by weight, a vinyl bond content of the butadiene part between 15% and 70%, a trans-1,4 bond content (in mol %) between 15% and 75% and a T_{g} between −10° C. and −55° C. are especially used. Such an SBR may be advantageously used with a BR preferably having more than 90 mol % of cis-1,4 bonds.

II-3) Bringing the Two Dispersions into Contact with Each Other

The two dispersions are brought into contact with each other. To allow good mixing of these solutions, they may for example be poured into a beaker with magnetic stirring. It is also possible to use any type of apparatus allowing “effective” mixing of two products in liquid phase, and also to use a static mixer such as static mixers sold by Noritake Co., Limited, by TAH in the United States, by KOFLO in the United States, or Tokushu Kika Kogyo Co., Ltd. or a high-shear mixer such as mixers sold by Tokushu Kika Kogyo Co., Ltd. or by PUC in Germany, or by Cavitron in Germany or by Silverson in the United Kingdom.

It is clear that the more effective the mixing step, the better the dispersion. It is therefore preferred to use mixers such as high-shear mixers.

During this phase of mixing the two dispersions together, a silica/elastomer coagulum forms, either in the form of a single solid element in solution or in the form of several separate solid elements.

As soon as the bringing into contact of the two dispersions has taken place, the pH, here the formulation pH, of this new dispersion is measured using the protocol described above in the tests.

Surprisingly, it has been found that in order to effectively obtain a coagulum, with an end-of-process yield of 80% or higher, which corresponds to obtaining a masterbatch respecting the initial filler weight ratio relative to the elastomer, thus a 20% difference relative to the initially calculated ratio is deemed to be, it was necessary to be in one of the following cases:
(i) formulation pH is between 3.5 and 5.5 and level of aluminium doping of the silica is equal to or greater than 0.5% by weight;
(ii) formulation pH is greater than 5.5 and level of aluminium doping of the silica is equal to or greater than (2×pH−10).

The volumes of the two dispersions brought into contact with each other, and in particular the volume of the silica dispersion, depend on the intended silica content for the masterbatch to be produced. Thus, the volume will be adapted accordingly. Advantageously, the intended silica content for the masterbatch is between 20 and 150 phr (parts by weight per one hundred parts of rubber), preferably between 30 and 100 phr, and more preferably between 30 and 90 phr, and even more preferably between 30 and 70 phr.

### II-4) Recovery of the Solid Formed.

The solid or solids recovered are filtered or centrifuged. The filtering operation that may be carried out using a filtration sieve may prove to be inappropriate when the coagulum takes the form of many small solid elements. In such a case, it is preferred to carry out an additional centrifuging operation. After this filtering or centrifuging step, the coagulum obtained is dried, for example in an oven.

After this operation, the amount of filler is measured by TGA and the coagulation yield is also measured.

IIE-5) Rubber composition

Advantageously, the masterbatches thus produced can be used in rubber compositions, especially for tyres. A person skilled in the art knows that too high an amount of aluminium in such rubber compositions may cause difficulties with respect to vulcanization and will prefer to limit the aluminium content present in the masterbatch by limiting the amount of silica doping to 3.5% by weight.

The rubber compositions for tyres based on masterbatches according to the invention also include, as is known, a coupling agent and a vulcanization system.

It will be recalled here that the term “coupling agent” is understood to mean, as is known, an agent capable of establishing a sufficient bond, of chemical and/or physical nature, between the inorganic filler and the diene elastomer. Such an at least difunctional coupling agent has for example the general simplified formula “Y-Z-X”, in which:
Y represents a functional group (“Y” function) which is capable of bonding physically and/or chemically to the inorganic filler, it being possible for such a bond to be established for example between a silicon atom of the coupling agent and the hydroxyl (OH) groups on the surface of the inorganic filler (for example the surface silanols when the filler is silica);
X represents a functional group (“X” function) capable of bonding physically and/or chemically to the diene elastomer, for example via a sulphur atom; and
Z represents a divalent group enabling Y to be linked to X.

Coupling agents, especially silica/diene elastomer coupling agents, have been described in a large number of documents, the most well known being difunctional organosilanes carrying alkoxyl functional groups (that is to say, by definition, alkoxysilanes) having “Y” functions and, as “X” functions, functional groups capable of reacting with the diene elastomer such as for example polysulphide functional groups.

Among known alkoxysilane polysulphide compounds that should be particularly mentioned are: bis(3-triethoxysilylpropyl) tetrasulphide (abbreviated to TESPT), having the formula [(C₂H₅O)₃Si(CH₂)₃S₂]₂, sold in particular by Degussa under the name “Si69” (or “X50S” when it is supported with 50% by weight on carbon black), in the form of a commercial blend of polysulphides S, with an average×value close to 4.

It should be noted that it is possible to envisage introducing the coupling agent during preparation of the masterbatch so as to obtain, directly, a silica/elastomer masterbatch that also contains a coupling agent. The coupling agent may thus be added before or during the operation of bringing the aqueous doped-silica dispersion into contact with the SBR latex.

These rubber compositions conforming to the invention may also contain all or some of the additives normally used in elastomer compositions intended for the manufacture of tyres, in particular of treads, such as for example plasticizers, oil extenders, whether the latter are of aromatic or non-aromatic nature, pigments, protective agents, such as antiozone waxes, chemical antiozonants, antioxidants, anti-fatigue agents, reinforcing resins, methylene acceptors (for example, phenol-novolac resin) or methylene donors (for example, HMT or H3M) as described, for example, in the application WO 02/10269, a crosslinking system based on either sulphur or on sulphur donors, and/or on a peroxide and/or on bismaleimides, vulcanization accelerators and vulcanization activators.

Preferably, these compositions comprise, as preferred non-aromatic or very weakly aromatic plasticizing agent, at least one compound chosen from the group consisting of naphthenic oils, paraffinic oils, MES oils, TDAE oils, glycerol esters (in particular trioleates), hydrocarbon-based plasticizing resins exhibiting a high T_{g} preferably greater than 30° C., and mixtures of such compounds.

These compositions may also contain, in addition to the coupling agents, coupling activators, covering agents (comprising for example the sole Y functional group) of the reinforcing inorganic filler or more generally processing aids known for improving the dispersion of the inorganic filler in the rubber matrix and for lowering the viscosity of the compositions, for improving their ease of processing in the uncured state, these agents being for example hydrolysable silanes, such as alkylalkoxysilanes (especially alkyltriethoxysilanes), polyols, polyethers (for example polyethyleneglycols), primary, secondary or tertiary amines (for example trialkanolamines), hydroxylated or hydrolysable POSs, for example α,ω-dihydroxy-polyorganosiloxanes (especially α,ω-dihydroxy-polydimethylsiloxanes), and fatty acids such as, for example, stearic acid.

The additives described above—oil, antioxidant and covering agent—could also be incorporated into the masterbatch before formation of the coagulum.

### II-6). Manufacture of the Rubber Compositions

The rubber compositions of the invention are manufactured in appropriate mixers, using two successive phases of preparation according to a general procedure well known to those skilled in the art: a thermomechanical kneading or working first phase (sometimes called “non-productive” phase) at high temperature, up to a maximum temperature of between 130° C. and 200° C. and preferably between 145° C. and 185° C., followed by a mechanical working second phase (sometimes called “productive” phase) at lower temperature, typically below 120° C., for example between 60° C. and 100° C., during which finishing phase the crosslinking or vulcanization system is incorporated.

According to a preferred embodiment of the invention, all the base constituents of the compositions of the invention, with the exception of the vulcanization system, namely the masterbatch, the coupling agent (if it is not already present in the masterbatch) and, where appropriate, the carbon black, are incorporated intimately, by kneading, into the diene elastomer during said non-productive first phase, that is to say at least these various base constituents are introduced into the mixer and thermomechanically kneaded, in one or more steps, until the maximum temperature of between 130° C. and 200° C., preferably between 145° C. and 185° C., is reached.

To give an example, the first (non-productive) phase is carried out in a single thermomechanical step during which all the necessary constituents, the possible complementary covering or processing agents and other various additives with the exception of the vulcanization system, are introduced into an appropriate mixer, such as a standard internal mixer. The total kneading time in this non-productive phase is preferably between 1 and 15 minutes. After the compound thus obtained during the non-productive first phase has cooled down, the vulcanization system is incorporated at low temperature, generally in an open mixer such as a two-roll mill, all the ingredients then being mixed (during the productive phase) for a few minutes, for example between 2 and 15 minutes.

When a covering agent is used, its incorporation may be carried out completely during the non-productive phase at the same time as the inorganic filler, or else completely during the productive phase at the same time as the vulcanization system, or else it may be divided over the two successive phases.

It should be noted that it is possible to introduce all or part of the covering agent in a supported form (the covering agent being placed on a support beforehand) on a solid compatible with the chemical structures corresponding to this compound. For example, during the division between the above two successive phases, it may be advantageous to introduce the second part of the covering agent, on the open mixer, after being placed on a support so as to make it easier to incorporate and disperse it.

The crosslinking system is preferably a vulcanization system, that is to say a system based on sulphur (or on a sulphur donor) and on a primary vulcanization accelerator. Various known vulcanization activators or secondary accelerators, such as zinc oxide, stearic acid or equivalent compounds, guanidine derivatives (in particular diphenylguanidine), are added to this base vulcanization system, these being incorporated during the non-productive first phase and/or during the productive phase as described below.

The sulphur is used at a preferred content of between 0.5 and 12 phr, in particular between 1 and 10 phr. The primary vulcanization accelerator is used at a preferred content of between 0.5 and 10 phr, more preferably between 0.5 and 5.0 phr.

It is possible to use as accelerator (whether primary or secondary) any compound capable of acting as an agent for accelerating the vulcanization of diene elastomers in the presence of sulphur, especially accelerators of the thiazole type and derivatives thereof, thiurame-type accelerators and zinc dithiocarbamates. These accelerators are for example chosen from the group formed by 2-mercaptobenzothiazyl disulphide (abbreviated to MBTS), tetrabenzylthiurame disulphide (TBZTD), N-cyclohexyl-2-benzothiazyl sulfenamide (CBS), N,N-dicyclohexyl-2-benzothiazyle sulfenamide (DCBS), N-tert-butyl-2-benzothiazyle sulfenamide (TBBS), N-tert-butyl-2-benzothiazyle sulfenimide (TBSI), zinc dibenzyldithiocarbamate (ZBEC) and mixtures of these compounds.

The final composition thus obtained is then calendered, for example in the form of a sheet or a plaque, especially for laboratory characterization, or else extruded in the form of a rubber strip that can be used for example as a tyre tread for a passenger vehicle.

### III EXEMPLARY EMBODIMENTS OF THE INVENTION

### III.1 Preparation of the Aluminium-Doped Silica

Methodology of the Al-doping operation carried out in the laboratory (intended doping level: 5 wt %).

Al-doping operation on a silica sold under the name 160 MP by Rhodia at the intended 5 wt % (theoretical mass of doped product produced: 165.30 g):
for the intended 5 wt % Al, 6.2 wt % Al is introduced, since the doping yield is approximately 70-80 wt % (source: patent WO 2002/051750 A1);
the pH is kept at 7.5 during the addition of aluminium sulphate so as to prevent the viscosity of the medium from strongly increasing.

### Equipment

One 5-litre double-walled reactor fitted with a bladed stirrer having 6 Teflon paddles;
One Heidolf stirring motor, model RZR2101;
One Huber thermostatted bath, model CC245;
Two Masterflex peristaltic pumps (model 7523-25 for 10 to 600 rpm or model 7523-37 for 1 to 100 rpm), fitted with an easy-load pump head, model 7518-60;
One calibrated, temperature-compensated, Mettler Toledo Inlab®Reach Pro pH electrode+1 MP225 Mettler Toledo pH meter;
One magnetic stirrer+one bar magnet;
Tygon tubing, glassware;
Ultra-Turrax® T25B rotor-stator homogenizer fitted with a seal generator shaft, N type S25N-18G and 1500-watt Vibracell generator manufactured by Sonics and Materials Inc. with a PZT crystal piezoelectric converter (reference 75010), a booster for the probe and a titanium alloy probe of 19 mm diameter (for a height of 127 mm).

The reactants are given in the following table:

| Rates of | | | |
|---|---|---|---|
| addition into | | | |
| the medium | Reactants | Details | Quantities |
| — | 160MP | MV: 6.26 wt % | 157.43 g dry |
| | | | equivalent, i.e. |
| | | | 167.95 g weighed |
| — | Demineralized | — | 3.9351 |
| | water | | |
| 15 ml/min | Al₂(SO₄)₃•18H₂O | 208 g/l Al₂(SO₄)₃ | 131.05 g in |
| | | aqueous solution | 258.78 g of water |
| | | (about 350 ml) | |
| 11-15 ml/min | NaOH | 5M | About 280 ml |
| 15 ml/min | H₂SO₄ | 0.82M | About 90 ml |

### Operating Method

The contents of two beakers [2×(83.97 g of 160 MP in 485.17 g of water)] are sheared using the aforementioned homogenizer for five minutes at 17500 rpm and then sonicated at 100% maximum power of a 1500 W probe, for eight minutes.

The suspension thus sheared is introduced into the reactor and 2964.67 ml of demineralized water added so as to obtain an initial concentration of 40 g/l, i.e. 3.8 wt %.

The medium is stirred at 650 rpm and heated to 60° C. (using a temperature probe integrated into the electrode and set at this temperature).

The Al₂(SO₄)₃.18H₂O is added at 15 ml/min and the pH of the medium is stabilized to 7.5 by simultaneously adding sodium hydroxide.

The reaction mixture is left, with stirring and heating, for 30 minutes (regulation of the pH to 7.5) and then the pH is lowered to 4.5 by adding H₂SO₄.

The medium is left with stirring and at temperature, for a further 10 minutes, for stabilizing the pH to 4.5, and then spin-dried, and the filler cake thus produced is washed with 10 litres of demineralized water. The cake obtained is resuspended in the demineralized water to a concentration of about 10 wt %.

Volatile matter in the suspension contained in the suspension flask (for the purpose of using it to manufacture masterbatches) is measured so as to know the precise mass concentration of the suspension.

### Equipment:

Mettler Toledo halogen moisture analyzer (thermobalance), model HR73, connected to a computer;
disposable aluminium sample pan (a consumable suitable for the apparatus).

### Operating Method:

After having obtained the information about the specimen and the measurement conditions (160° C. with no temperature ramp, duration 30 minutes) and after having calibrated the aluminium sample pan, about 2.5 g of specimen are introduced into the sample pan and the measurement is started.

The protocol to be followed for the different doping levels is identical, with the exception of the amount of aluminium precursor salt to be introduced, and is summarized in Table 1 below, in which the amounts of aluminium salt used are given for the intended doping levels.

TABLE 1
Al doping

| intended doping level (wt %) | Mass of aluminium salt (g) |
|---|---|
| 2.5 | 52.42 |
| 1 | 19.44 |

### III.2 Preparation of the Masterbatches

The aluminium-doped silicas obtained above are dispersed in water so as to obtain a concentration of 4% by weight of silica in the water.

Each silica dispersion, sonicated and then left with stirring for 10 minutes (with possible adjustment of the pH during the final minute), is brought into contact with a concentrated natural rubber latex maintained under magnetic stirring, the aqueous silica dispersion being poured very rapidly into this latex.

The volume of the aqueous doped-silica dispersion is adapted relative to the volume of the latex according to the concentration of the silica and the concentration of the latex in order to have, upon bringing the two dispersions (silica and elastomer latex) into contact with each other, the desired formulation pH.

For examples, an amount of silica of 50 parts by weight per one hundred parts of elastomer was chosen, corresponding here to 50% mo (because masterbatches described here comprise only the silica and the diene elastomer).

As soon as all of the aqueous doped-silica dispersion has been poured, the pH measurement electrode is inserted into the mixture so as to measure the formulation pH. As explained previously, to obtain the desired pH it is necessary to adjust the pH of the aqueous doped-silica dispersion after it has been sheared but before it has been brought into contact with the latex. It is therefore necessary to carry out an experiment in order to adjust the pH of the aqueous doped-silica dispersion.

The mixture is kept for a few minutes with magnetic stirring before the coagulum formed is recovered. So as to have identical operating method conditions for the various trials, the coagulum formed, or the solids (commonly called crumbs) formed, are centrifuged, including in the cases when the visual appearance of the coagulum allows a filtering operation to be envisaged. After transfer to a 250 ml Nalgene bottle, the centrifugation is carried out using a Sigma 4K15 bucket centrifuge at 8000 rpm for 10 minutes.

The coagulum thus recovered is dried under a fume hood at room temperature for 24 hours and then in an oven for 24 hours at 65° C. under a pressure of 300 mbar so as to remove the last traces of water.

The filler content is then measured by TGA and the coagulation yield determined.

### III-3 Example 1

The purpose of this example is to demonstrate the proper operation of the method according to the invention, in particular with regard to the measured formulation pH. Trials E1, E2 and E3 were carried out in accordance with the method detailed in the above section with:
an SBR latex prepared in emulsion with 39% of styrene, 15% of 1,2-polybutadiene units, 74% of trans-1,4-polybutadiene units and 11% of cis-1,4-polybutadiene units (T_{g}=−33° C.);
an aluminium-doped silica with a doping level of 1% by weight; and
an amount of silica, upon bringing the two dispersions into contact with each other, of 50 phr.

The sole difference between these three trials consists, during the operating method detailed above, of the modification of the pH of the aqueous doped-silica dispersion so as to modify the formulation pH.

Thus trials E1, E2 and E3 differ from one another by their formulation pH upon the bringing into contact of the dispersions (the aqueous silica dispersion and the elastomer latex) as follows:
in the case of E1, the formulation pH was 3.5;
in the case of E2, the formulation pH was 5.5;
in the case of E3, the formulation pH was 6.5.

The results obtained (yield and filler content) for these three trials are given in Table 2 below:

TABLE 2

| | | | Filler content |
|---|---|---|---|
| Trial | Formulation pH | Yield (wt %) | (% mo) |
| E1 | 3.5 | 95.7 | 47.4 |
| E2 | 5.5 | 95.7 | 47.4 |
| E3 | 6.5 | 62 | 90.4 |

For trial E3 (the formulation pH of which is 6.5), the table shows that the coagulation yield is less than 80% and therefore outside the acceptable tolerance. The silica content for trial E3 is also outside the acceptable tolerance (20% difference relative to the 50% mo target), which means that only a portion of the elastomer has coagulated with the silica. For trials E1 and E2, acceptable silica contents (between 40% mo and 60% mo) are obtained at the same time as a greater than 80% yield.

### III-4 Example 2

The purpose of this example is to demonstrate the proper operation of the method according to the invention, in particular with respect to the formulation pH measured for a level of silica doping different from Example 1.

Trials E′ 1, E′2 and E′3 were carried out in accordance with the method detailed in the previous section with an SBR latex as that cited in Example 1 and with aluminium-doped silica with a doping level of 2.5% by weight, the amount of silica, upon bringing the two dispersions into contact with each other, being 50 per.

As in Example 1, the sole difference between these three trials consists, carrying out the operating method described above, of the modification of the pH of the aqueous doped-silica dispersion so as to modify the formulation pH, thus:
in the case of E′ l, the formulation pH is 3.5;
in the case of E′2, the formulation pH is 6;
in the case of E′3, the formulation pH is 7.5.

The results obtained for these three trials are given in Table 3 below.

TABLE 3

| | | | Filler content |
|---|---|---|---|
| Trial | Formulation pH | Yield (wt %) | (% mo) |
| E′1 | 3.5 | 95.3 | 41.5 |
| E′2 | 6 | 97.1 | 46.5 |
| E′3 | 7 | 50.6 | 132.4 |

This table shows that in the case of trial E′3 (the formulation pH of which is 7) that the coagulation yield is less than 80% and therefore outside the acceptable tolerance. The silica content in the case of trial E′3 is also outside the acceptable tolerance (20% difference in relation to the 50% mo target), while the very high silica content obtained shows that a small portion of the elastomer has coagulated with the silica.

In contrast, trials E′ 1 and E′2 allow masterbatches to be obtained with both acceptable silica contents (between 40% mo and 60% mo) and a coagulation yield of greater than 80%.

These two examples clearly show that it is important to be within a given formulation pH range for a given silica doping level in order to meet the desired criteria in terms of respective filler content and yield obtained.

1. A method for preparing a silica/synthetic diene elastomer masterbatch, comprising in succession:
doping a silica with an at least divalent metallic element to form a doped-silica;
preparing at least one dispersion of the doped silica in water to form an aqueous doped-silica dispersion;
bringing a synthetic elastomer latex into contact with the aqueous doped-silica dispersion and mixing them together to form a formulation and to obtain a coagulum;
recovering the coagulum; and
drying the recovered coagulum to obtain a silica/synthetic diene elastomer masterbatch.

2. The method according to claim 1, wherein recovering the coagulum comprises filtering.

3. The method according to claim 1, wherein recovering the coagulum comprises centrifuging.

4. The method according to claim 1, wherein the synthetic elastomer latex is a styrene-butadiene copolymer, or SBR, latex.

5. The method according to claim 4, in which the synthetic elastomer latex is an SBR prepared in emulsion.

6. The method according to claim 1, wherein the silica is a precipitated silica.

7. The method according to claim 1, wherein the metallic element is aluminium.

8. The method according to claim 7, wherein one of the following conditions is satisfied:
(i) the formulation has a pH of between 3.5 and 5.5 and the level of aluminium doping of the silica is equal to or greater than 0.5% by weight; or
(ii) the formulation has a pH of greater than 5.5 and the level of aluminium doping of the silica is equal to or greater than (2×pH−10).

9. The method according to claim 1, wherein the amount of silica upon bringing the synthetic elastomer latex into contact with the aqueous doped-silica dispersion is between 20 phr and 150 phr (parts per one hundred parts by weight of elastomer).

10. The method according to claim 9, wherein the amount of silica upon bringing the synthetic elastomer latex into contact with the aqueous doped-silica dispersion is between 30 phr and 100 phr.

11. The method according to claim 10, wherein the amount of silica upon bringing the synthetic elastomer latex into contact with the aqueous doped-silica dispersion is between 30 phr and 90 phr.

12. The method according to claim 4, further comprising adding an aqueous coupling agent dispersion before or upon bringing the aqueous doped-silica dispersion into contact with the SBR latex.

13. A silica/synthetic diene elastomer masterbatch prepared according to claim 1.

14. The masterbatch according to claim 13, wherein the silica content is between 20 phr and 150 phr.

15. The masterbatch according to claim 14, wherein the silica content is between 30 phr and 100 phr.

16. The masterbatch according to claim 15, wherein the silica content is between 30 phr and 90 phr.

17. A rubber composition based on at least one silica/synthetic diene elastomer masterbatch prepared according to claim 1.

18. A finished or semi-finished article comprising a composition according to claim 17.

19. A tire tread comprising a composition according to claim 17.

20. A tire or semi-finished product comprising at least one rubber composition according to claim 17.
